(19) United States
(12) Patent Application Publication
(10) Pub. No.: US 2020/0183647 A1
(43) Pub. Date: Jun. 11, 2020

(54) Light-Emitting Diode (LED) Voice Controller and LED Lamp

(71) Applicant: Changzhou Jutai Electronic Co., Ltd., Changzhou (CN)

(72) Inventors: Hui GAO, Changzhou (CN); Min FANG, Changzhou (CN); Chengqian PAN, Changzhou (CN); Bin CHEN, Changzhou (CN)

(73) Assignee: Changzhou Jutai Electronic Co., Ltd.

(21) Appl. No.: 16/690,917

(22) Filed: Nov. 21, 2019

(30) Foreign Application Priority Data
Dec. 11, 2018 (CN) 201822067719.3

(51) Int. Cl. G06F 3/16; H05B 33/08; G06F 1/16

(52) U.S. Cl. CPC G06F 3/167; G06F 1/1626; H05B 33/0863

(57) ABSTRACT

This invention has an LED voice controller with an LED luminous mode control unit and a voice forwarding unit, converting a voice control instruction picked up from a user into an audio signal for output; a first transfer unit, transferring the audio signal output by the voice forwarding unit; and a conversion unit, converting the audio signal into a regulation instruction recognizable by the LED luminous mode control unit for output to the first transfer unit, which the LED luminous mode control unit outputs a control signal for LED regulation after receiving the regulation instruction sent by the first transfer unit; or the voice forwarding unit outputs the regulation instruction to the LED luminous mode control unit after receiving the regulation instruction sent by the first transfer unit, and the LED luminous mode control unit outputs the control signal for LED regulation after receiving the regulation instruction.

### CROSS-REFERENCE TO RELATED APPLICATIONS

This application claims priority to Chinese Patent Application No. 201811201174.9 with a filing date of Oct. 16, 2018 and Chinese Patent Application No. 201822067719.3 with a filing date of Dec. 11, 2018. The content of the aforementioned applications, including any intervening amendments thereto, are incorporated herein by reference.

### TECHNICAL FIELD

The present utility model relates to the technical field of illumination, and particularly relates to an LED voice controller and an LED lamp.

### BACKGROUND ART

Attribute to the advantages of high luminous efficiency, long service life, low driving voltage, quick response and low power consumption, an LED lamp has broad market and application prospect. Along with development of sciences and technologies, LED illumination with advantages of energy conservation, long service life, multiple colors and the like is gradually replacing conventional incandescent lamps, and more and more researches on LED illumination equipment have been made at home and abroad. Along with development of the field of LED illumination, people pay more and more attention on intelligent illumination equipment, and may regulate brightness, tone, turning-on/off and the like of lamps through intelligent control equipment such as mobile phones and tablet computers according to practical conditions in daily lives.

Chinese Patent Application CN103369790A discloses an LED illumination device and an illumination control system and relates to a wireless controlled LED lamp driving system, which includes a WIFI receiving module, a regulation module and an LED light source module. A WIFI signal is received through the WIFI receiving module, and brightness and color temperature of an LED lamp are controlled through the WIFI signal. Therefore, convenience for use is improved, and production cost is reduced.

Chinese Patent Application CN103986630A discloses an LED illumination device-based wireless network system and intelligent equipment management method. A WIFI module is arranged in an LED illumination device. An illumination function is realized, and meanwhile, the LED illumination device may be connected to a wireless router or wirelessly connected LED illumination equipment through the WIFI module. Therefore, centralized and unified control is facilitated.

The foregoing LED lamp may be controlled through intelligent equipment. However, without exception, the foregoing operating manner is to operate, by a user, an APP on the intelligent equipment to send a regulation signal, transmit the regulation signal to a controller controlling the LED lamp through a gateway (router) and output, by the controller, a control instruction of changing the LED lamp (as shown in FIG. 1). Such a control manner is single and cannot be flexibly and rapidly adapted to requirement changes.

### SUMMARY OF THE INVENTION

The present utility model is directed to provide an LED voice controller and an LED lamp. According to the present utility model, a luminous state of an LED can be changed through a voice.

The foregoing technical problem is solved through the following technical solutions.

An LED voice controller includes an LED luminous mode control unit, and further includes:

a voice forwarding unit, converting a voice control instruction picked up from a user into an audio signal for output;

a first transfer unit, transferring the audio signal output by the voice forwarding unit; and

a conversion unit, converting the audio signal into a regulation instruction recognizable by the LED luminous mode control unit for output to the first transfer unit, wherein

the LED luminous mode control unit outputs a control signal for LED regulation after receiving the regulation instruction sent by the first transfer unit; or the voice forwarding unit outputs the regulation instruction to the LED luminous mode control unit after receiving the regulation instruction sent by the first transfer unit, and the LED luminous mode control unit outputs the control signal for LED regulation after receiving the regulation instruction.

An LED voice controller includes an LED luminous mode control unit, and further includes:

a voice forwarding unit, converting a voice control instruction picked up from a user into an audio signal for output;

a first transfer unit, transferring the audio signal output by the voice forwarding unit;

a conversion unit, converting the audio signal into a regulation instruction recognizable by the LED luminous mode control unit for output; and

a second transfer unit, forwarding the regulation instruction output by the conversion unit to the LED luminous mode control unit for the LED luminous mode control unit to output a control signal for LED regulation according to the regulation instruction.

An LED voice controller includes an LED luminous mode control unit, and further includes:

a voice forwarding unit, converting a voice control instruction picked up from a user into an audio signal and outputting it through mobile data communication;

a first transfer unit, transferring the audio signal output by the voice forwarding unit; and

a conversion unit, converting the audio signal into a regulation instruction recognizable by the LED luminous mode control unit for output, wherein

the regulation instruction output by the conversion unit is received by the first transfer unit and then sent to the voice forwarding unit through mobile data communication, and then the voice forwarding unit sends the regulation instruction to the LED luminous mode control unit through Bluetooth.

An LED lamp includes an LED lamp bank, and further includes an LED voice controller, and the LED lamp bank is connected to an output end of the LED voice controller.

The present utility model has the advantages that when needing to change a luminous mode of an LED, the user orally expresses a required luminous mode to the voice forwarding unit, the voice forwarding unit converts the voice into the audio signal for output, the first transfer unit transfers the audio signal output by the voice forwarding unit, then the conversion unit converts it into the regulation instruction recognizable by the LED luminous mode control unit for output, and finally, the LED luminous mode control unit outputs the control signal for LED regulation, after receiving the regulation instruction. From this process, it can be seen that, when dimming is required, the user is only required to orally express the required luminous mode. Therefore, a control manner in the present utility model has the advantages of simplicity and interestingness for the user.

### BRIEF DESCRIPTION OF THE DRAWINGS

FIG. 1 is a schematic diagram of controlling an LED lamp through intelligent equipment in the prior art;

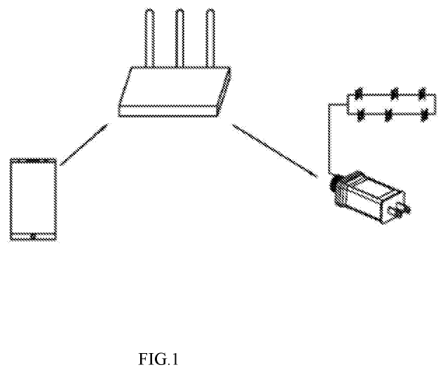

FIG. 2 is a schematic diagram of Embodiment 1 of an LED voice controller according to the present utility model;

FIG. 3 is a circuit schematic diagram of an LED luminous mode control unit;

FIG. 4 is a schematic diagram of Embodiment 2 of an LED voice controller according to the present utility model;

FIG. 5 is a schematic diagram of Embodiment 3 of an LED voice controller according to the present utility model;

FIG. 6 is a schematic diagram of Embodiment 4 of an LED voice controller according to the present utility model;

FIG. 7 is a schematic diagram of Embodiment 5 of an LED voice controller according to the present utility model;

FIG. 8 is a schematic diagram of Embodiment 6 of an LED voice controller according to the present utility model; and

FIG. 9 is a schematic diagram of connecting the first embodiment of the present utility model to an LED lamp bank.

### DETAILED DESCRIPTION OF THE INVENTION

### Embodiment 1

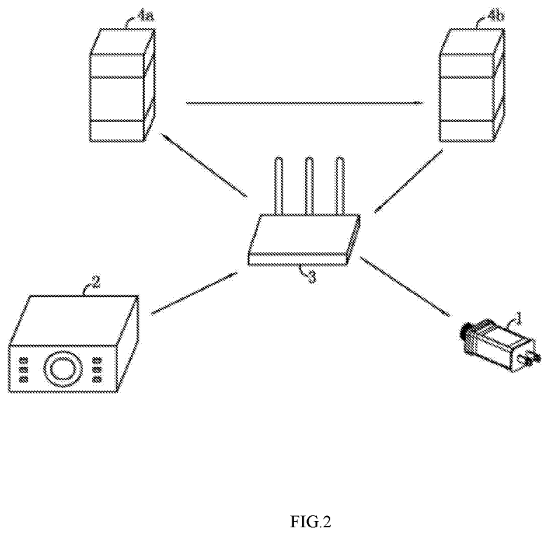

FIG. 2 illustrates Embodiment 1 of an LED voice controller of the present utility model, which includes an LED luminous mode control unit 1, a voice forwarding unit 2, a first transfer unit 3 and a conversion unit. Each part and a relationship therebetween will be described below in detail.

As shown in FIG. 2, the LED luminous mode control unit 1 consists of a shell, a plug and a control circuit mounted in the shell. One end of the plug extends into the shell and is electrically connected to the control circuit. The plug is also fixed to the shell. Preferably, the plug is integrated with the shell by injection molding.

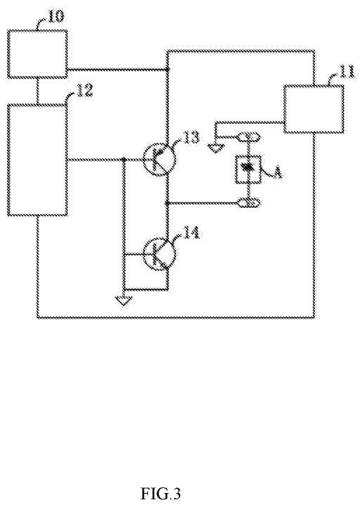

FIG. 3 illustrates the control circuit. The control circuit includes a power circuit 10, a wireless signal receiving circuit 11 configured to receive a regulation instruction, a luminous mode control circuit 12 and a driving circuit. Since the plug mounted on the shell is connected to a socket of an alternating current power supply, the power circuit 10 converts a high-voltage alternating current into a low-voltage direct current. The low-voltage direct current output by the power circuit 10 is provided for the wireless signal receiving circuit 11, the luminous mode control circuit 12 and the driving circuit.

The wireless signal receiving circuit 11 communicates with equipment located outside the LED luminous mode control unit 1, receives the regulation instruction output by the external equipment and outputs the regulation instruction to the luminous mode control circuit 12. In this implementation, the wireless signal receiving circuit 11 adopts a WIFI module.

The luminous mode control circuit 12 outputs a control signal for LED regulation according to the regulation instruction provided by the wireless signal receiving circuit 11. The luminous mode control circuit 12 adopts a single-chip microcomputer. A program controlling an LED lamp bank is preset in the luminous mode control circuit 12, and the output signal passes through the driving circuit to enable the LED lamp bank to present various flashing states or colors and color temperatures and also cycle between these states.

The driving circuit includes a first triode 13 and a second triode 14. Bases of the first triode 13 and the second triode 14 are connected to an output end of the luminous mode control circuit 12, an emitter of the first triode 13 is connected to an output end of the power circuit 10, a collector of the first triode 13 is connected to a collector of the second triode 14, and an emitter of the second triode 14 is grounded. When the luminous mode control circuit 12 outputs a high level, the first triode 13 is in an off state, and the second triode 14 is in an on state. When the luminous mode control circuit 12 outputs a low level, the first triode 13 is in an on state, and the second triode 14 is in an off state. Therefore, the luminous mode control circuit 12 outputs a high level and a low level, and the first triode 13 and the second triode 14 are alternately turned on to further alternately output control signals output by the luminous mode control circuit 12.

The driving circuit consists of the first triode 13 and the second triode 14, so that the LED lamp bank A is structurally simplified. Specifically, for an LED lamp string connected to an ordinary driving circuit (for example, a bridge driving circuit in CN203523098U), LEDs in the LED lamp string are monochromatic LEDs and each LED cannot emit light in different colors. The LED lamp bank A in the present utility model consists of lamp beads, and the number of the lamp beads is set as required. However, a control chip is adopted in each lamp bead, and LEDs of at least three colors (a red LED, a green LED and a blue LED) are connected to an output end of the control chip. In such a manner, light emitted by each lamp bead is polychromatic, and different colors may be mixed to form light in various colors. Therefore, the driving circuit driving the LED lamp bank A is simpler in structure and favorable for cost reduction. An LED lamp in the prior art is provided with at least four input ends, so that a driving circuit with four paths of output is required for connection with the LED lamp beads. While only one path of output is required for connection with the LED lamp beads in the present utility model.

The voice forwarding unit 2 converts a voice control instruction picked up from a user into an audio signal for output. The voice forwarding unit 2 is a voice forwarding unit with a wireless communication module. In this embodiment, the voice forwarding unit 2 at least includes a pickup module, a voice conversion module and a WIFI module. The pickup module picks up a voice produced by the user and sends it to the voice conversion module, the voice conversion module converts the voice into the audio signal, and then the WIFI module sends it to the first transfer unit. In this embodiment, the voice forwarding unit 2 preferably adopts an intelligent speaker, and the intelligent speaker preferably adopts an intelligent speaker produced by Amazon (alexa (voice assistant)-based intelligent speaker).

The first transfer unit 3 transfers the audio signal output by the voice forwarding unit 2. The first transfer unit 3 is a router. The router preferably adopts a wireless router. The first transfer unit 3 ensures smooth communication among the LED luminous mode control unit 1, the voice forwarding unit 2 and the conversion unit.

The conversion unit converts the audio signal into a regulation instruction recognizable by the LED luminous mode control unit for output to the first transfer unit. The conversion unit includes a first conversion unit 4a and a second conversion unit 4b. The first conversion unit 4a converts the audio signal into a coded instruction. The second conversion unit 4b converts the coded instruction into the regulation instruction recognizable by the LED luminous mode control unit 1 for output to the first transfer unit 3. The first transfer unit 3, the first conversion unit 4a and the second conversion unit 4b communicate with one another through an optical fiber.

The first conversion unit 4a is a voice cloud server. In this example, the intelligent speaker adopted for the voice forwarding unit 2 has a corresponding voice conversion server. However, since an intelligent speaker produced by each manufacturer usually has its own corresponding voice conversion server, each LED luminous mode control unit 1 may not be applied to recognition of codes output by various voice conversion servers. Therefore, a converter capable of recognizing and converting coded instructions output by various voice cloud servers is required. In this embodiment, data corresponding to coded instructions output by various voice cloud servers is stored in the second conversion unit 4b. For example, the intelligent speaker adopts the intelligent speaker produced by Amazon, a coded instruction output by a voice cloud server of Amazon is 01F, then data 00F corresponding to the coded instruction 01F is stored in the second conversion unit 4b, and the second conversion unit 4b calls and outputs a corresponding regulation instruction through the data 00F, thereby changing the control signal output by the LED luminous mode control unit 1.

In this embodiment, since a communication module in the voice forwarding unit 2 is a WIFI module and the wireless signal receiving circuit 11 is also a WIFI module, after the first transfer unit 3 receives the regulation instruction output by the second conversion unit 4b, the first transfer unit 3 directly outputs the regulation instruction to the LED luminous mode control unit 1, and the LED luminous mode control unit 1 outputs the control signal for LED regulation after receiving the regulation instruction sent by the second transfer unit 4b to further change a luminous mode of the LEDs.

### Embodiment 2

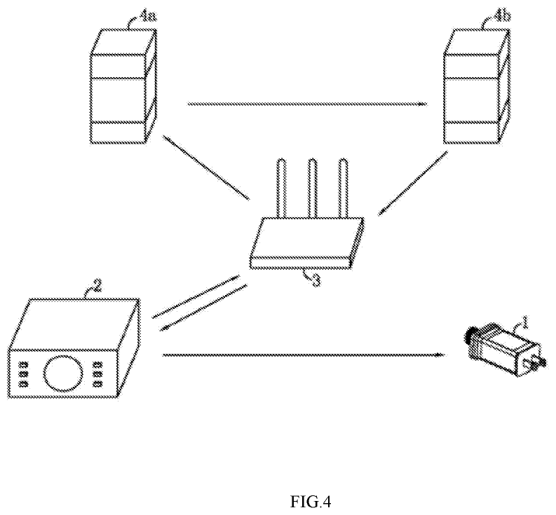

As shown in FIG. 4, the difference between this embodiment and Embodiment 1 is that: the wireless signal receiving circuit 11 is a Bluetooth module, and the wireless communication module in the voice forwarding unit 2 consists of a WIFI module and a Bluetooth module, wherein the WIFI module is responsible for sending the audio signal converted by the voice conversion module, and the Bluetooth module in the voice forwarding unit 2 is responsible for receiving the regulation instruction output by the first transfer unit 3, so that the voice forwarding unit outputs the regulation instruction to the LED luminous mode control unit 1 after receiving the regulation instruction sent by the first transfer unit 3, and the LED luminous mode control unit outputs the control signal for LED regulation after receiving the regulation instruction. In such a manner, the regulation instruction received by the LED luminous mode control unit 1 is not from the first transfer unit 3 but from the voice forwarding unit 2, and the voice forwarding unit 2 and the LED luminous mode control unit 1 communicate with each other through Bluetooth.

### Embodiment 3

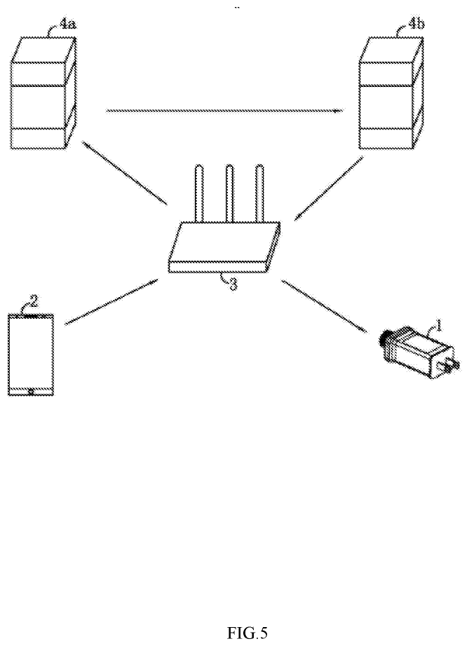

As shown in FIG. 5, the difference between this embodiment and Embodiment 1 is that: the voice forwarding unit 2 is a smart phone or a tablet computer, software similar to voice assistant software in the intelligent speaker of Amazon is mounted on the smart phone or the tablet computer, and the audio signal is formed after conversion with the voice assistant software, and is output through the WIFI module on the smart phone or the tablet computer.

### Embodiment 4

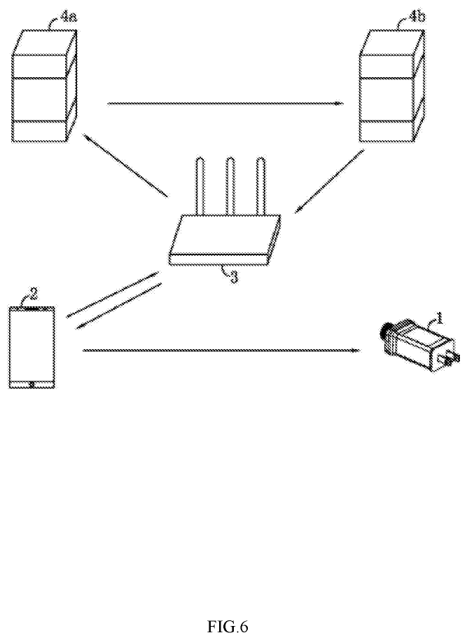

As shown in FIG. 6, the difference between this embodiment and Embodiment 2 is that: the voice forwarding unit 2 is a smart phone or a tablet computer, software similar to voice assistant software in the intelligent speaker of Amazon is mounted on the smart phone or the tablet computer, and the audio signal is formed after conversion with the voice assistant software, and is output through the WIFI module on the smart phone or the tablet computer.

### Embodiment 5

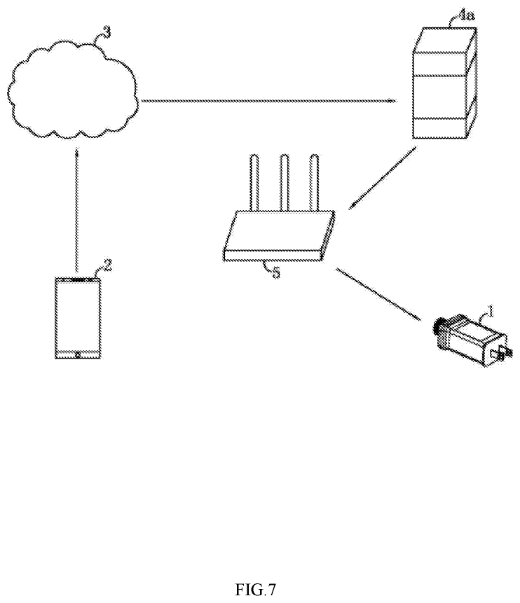

As shown in FIG. 7, the difference between this embodiment and Embodiment 1 is that: the voice forwarding unit 2 is a smart phone or a tablet computer. Second, the first transfer unit 3 is mobile communication equipment, so that the smart phone or the tablet computer sends a voice signal to the first transfer unit 3 through mobile data communication, and then the first transfer unit 3 sends the audio signal to the conversion unit. The conversion unit in this embodiment is the first conversion unit 4a converting the coded instruction into the regulation instruction. That is, a function of the second conversion unit in Embodiments 1 to 4 is integrated into the first conversion unit 4a, so that the first conversion unit 4a not only completes a process of converting the audio signal into the coded instruction but also completes a process of converting the coded instruction into the regulation instruction. The regulation instruction output by the conversion unit is forwarded to the LED luminous mode control unit 1 through the second transfer unit 5, and the LED luminous mode control unit 1 outputs the control signal for LED regulation according to the regulation instruction.

### Embodiment 6

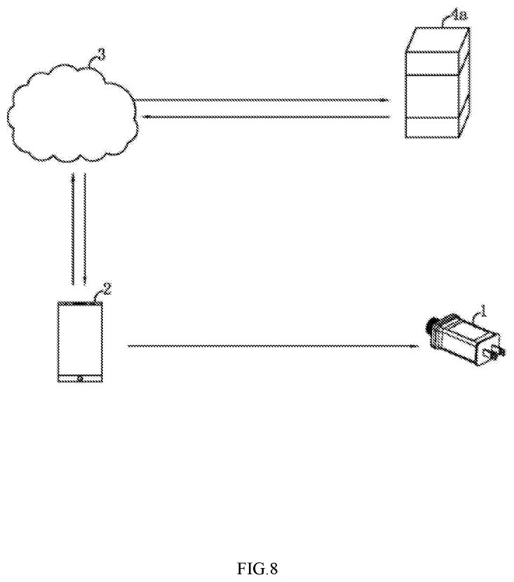

As shown in FIG. 8, the difference between this embodiment and Embodiment 1 is that:

the voice forwarding unit 2 is a smart phone or a tablet computer. Second, the first transfer unit 3 is mobile communication equipment, so that the smart phone or the tablet computer sends the voice signal to the first transfer unit 3 through mobile data communication, and then the first transfer unit 3 sends the audio signal to the conversion unit. The conversion unit in this embodiment is the first conversion unit 4a converting the coded instruction into the regulation instruction. That is, the function of the second conversion unit in Embodiments 1 to 4 is integrated into the first conversion unit 4a, so that the first conversion unit 4a not only completes the process of converting the audio signal into the coded instruction but also completes the process of converting the coded instruction into the regulation instruction. The regulation instruction output by the first conversion unit 4a is received by the first transfer unit 3 and then sent to the voice forwarding unit 2 through mobile data communication, and then the voice forwarding unit 2 sends the regulation instruction to the LED luminous mode control unit 1 through the Bluetooth module.

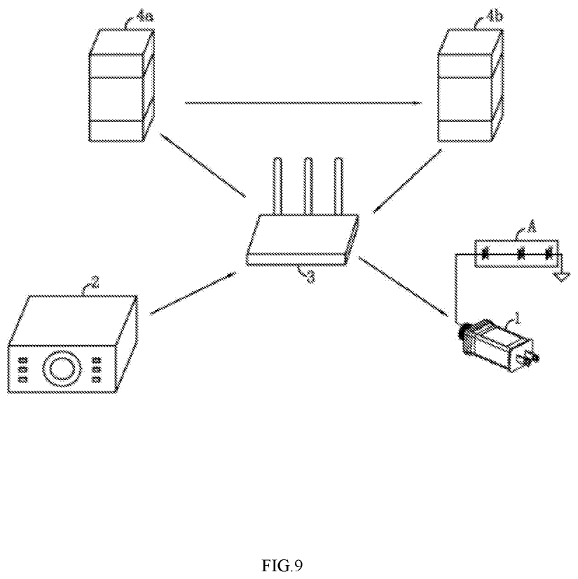

As shown in FIG. 9, an LED lamp of the present utility model includes an LED lamp bank A, and further includes the LED voice controller in any one of Embodiments 1 to 6. The LED lamp bank A is connected to an output end of the LED voice controller.

We claim:

1. An LED voice controller, comprising an LED luminous mode control unit and further comprising:
a voice forwarding unit, converting a voice control instruction picked up from a user into an audio signal for output;
a first transfer unit, transferring the audio signal output by the voice forwarding unit; and
a conversion unit, converting the audio signal into a regulation instruction recognizable by the LED luminous mode control unit for output to the first transfer unit, wherein
the LED luminous mode control unit outputs a control signal for LED regulation after receiving the regulation instruction sent by the first transfer unit; or the voice forwarding unit outputs the regulation instruction to the LED luminous mode control unit after receiving the regulation instruction sent by the first transfer unit, and the LED luminous mode control unit outputs the control signal for LED regulation after receiving the regulation instruction.

2. The LED voice controller according to claim 1, wherein the voice forwarding unit is a voice forwarding unit with a wireless communication module.

3. The LED voice controller according to claim 2, wherein the voice forwarding unit is a smart phone, or a tablet computer or an intelligent speaker.

4. The LED voice controller according to claim 1, wherein the first transfer unit is a router.

5. The LED voice controller according to claim 1, wherein the conversion unit comprises:
a first conversion unit, converting the audio signal into a coded instruction; and
a second conversion unit, converting the coded instruction into the regulation instruction recognizable by the LED luminous mode control unit for output to the first transfer unit.

6. The LED voice controller according to claim 5, wherein the first conversion unit is a voice cloud server.

7. The LED voice controller according to claim 1, wherein the LED luminous mode control unit comprises:
a power circuit;
a wireless signal receiving circuit configured to receive the regulation instruction;
a luminous mode control circuit, outputting the control signal for LED regulation according to the regulation instruction provided by the wireless signal receiving module; and
a driving circuit, comprising a first triode and a second triode, bases of the first triode and the second triode being connected to an output end of the luminous mode control circuit, an emitter of the first triode being connected to an output end of the power circuit, a collector of the first triode being connected to a collector of the second triode and an emitter of the second triode being grounded.

8. An LED voice controller, comprising an LED luminous mode control unit and further comprising:
a voice forwarding unit, converting a voice control instruction picked up from a user into an audio signal for output;
a first transfer unit, transferring the audio signal output by the voice forwarding unit;
a conversion unit, converting the audio signal into a regulation instruction recognizable by the LED luminous mode control unit for output; and
a second transfer unit, forwarding the regulation instruction output by the conversion unit to the LED luminous mode control unit for the LED luminous mode control unit to output a control signal for LED regulation according to the regulation instruction.

9. An LED voice controller, comprising an LED luminous mode control unit and further comprising:
a voice forwarding unit, converting a voice control instruction picked up from a user into an audio signal and outputting it through mobile data communication;
a first transfer unit, transferring the audio signal output by the voice forwarding unit; and
a conversion unit, converting the audio signal into a regulation instruction recognizable by the LED luminous mode control unit for output, wherein
the regulation instruction output by the conversion unit is received by the first transfer unit and then sent to the voice forwarding unit through mobile data communication, and then the voice forwarding unit sends the regulation instruction to the LED luminous mode control unit through Bluetooth.

10. An LED lamp, comprising an LED lamp bank and further comprising the LED voice controller of claim 1, wherein the LED lamp bank is connected to an output end of the LED voice controller.
